(19) United States
(12) Patent Application Publication
(10) Pub. No.: US 2014/0244510 A1
(43) Pub. Date: Aug. 28, 2014

(54) PRIVACY PROTECTION SYSTEM AND METHOD

(71) Applicant: Raymond de Beasley, Dallas, TX (US)

(72) Inventor: Raymond de Beasley, Dallas, TX (US)

(21) Appl. No.: 14/271,988

(22) Filed: May 7, 2014

Related U.S. Application Data
(63) Continuation-in-part of application No. 11/805,330, filed on May 23, 2007, now abandoned.
(60) Provisional application No. 61/820,408, filed on May 7, 2013.

(51) Int. Cl. G06Q 50/26; G06Q 20/04; G06Q 20/38

(52) U.S. Cl. CPC G06Q 50/265; G06Q 20/385; G06Q 20/042
USPC 705/44; 705/325

(57) ABSTRACT

Disclosed herein are privacy protection systems and related methods for providing subscribers of the system or method, such as credit card issuers, banks, etc., independent verification of the identity of individuals attempting to do business with the subscriber. The independent verification disclosed herein does not rely solely on the information accessible or maintained by an entity that issued a piece of identification data to the individual. Instead, disclosed systems and methods may not only check with the entity that issued the piece(s) of identification data presented by a user to identify himself, but also may review the records of that issuing entity such that older records can be actively compared to current records in an effort to determine if the currently issued identification data is correct. Furthermore, the disclosed technique checks at least one other informational source to verify the identity of the user, and typically several other source of information that are not related to one another and are not administered by the entity issuing the identification data to the individual.

### PRIORITY CLAIM

The present application is a non-provisional conversion of, and thus claims priority to, U.S. Provisional Patent Application No. 61/820,408, filed May 7, 2013, and also is a continuation-in-part application of, and thus also claims priority to, co-pending U.S. patent application Ser. No. 11/805,330, filed May 23, 2007; the disclosures of each of these applications are incorporated by reference herein in their entireties for all purposes.

### TECHNICAL FIELD

The present disclosure relates generally to security systems and methods for preventing identity theft, and more particularly to privacy protection systems and related methods for providing subscribers of the system or method, such as credit card issuers, banks, etc., independent verification of the identity of individuals attempting to do business with the subscriber.

### BACKGROUND

The ability to use fraudulently and/or illegally obtained identity information continues to increase each year. Once obtained, a criminal can use the illegally obtained identity information for financial gain, such as for example, opening bank accounts to create financial scams and opening credit cards. Using illegally obtained identity information to target businesses and financial and credit account providers financially burdens taxpayers, businesses and the victims of the identity theft.

### SUMMARY

Disclosed herein are privacy protection systems and related methods for providing subscribers of the system or method, such as credit card issuers, banks, etc., independent verification of the identity of individuals attempting to do business with the subscriber. The independent verification provided by a protection system or method in accordance with the disclosed principles does not rely solely on the information accessible by an entity that issued a piece of identification data to the individual. Instead, not only does a system or method in accordance with the disclosed principles check with the entity that issued the piece(s) of identification data presented by a user to identify himself, but it also may review the historical records of that issuing entity such that older records can be actively compared to current records in an effort to determine if the currently issued identification data is correct. Furthermore, as discussed in detail below, the disclosed technique also checks at least one other informational source, and typically several other source of information that are not related to one another and are not administered by the entity issuing the identification data to the individual.

In one embodiment, a privacy protection method in accordance with the disclosed principles may comprise registering a subscriber with the privacy protection method, wherein the subscriber provides goods or services to users and wishes to verify the identity of such users. Such an exemplary method may further comprise receiving identification data purported to identify a user of the subscriber's goods or services. Such identification data may be received directly from the user or it may be received via the subscriber. Furthermore, such a method may include accessing at least two information sources having records related to the identification data, wherein the at least two information sources are unrelated to one another. Then an exemplary method could include determining if the identification data accurately identifies the user using one or more of the related records from each of the at least two information sources. Based on the results of the determination, the exemplary method may then verify the identity of the user to the subscriber or inform the subscriber that the identity of the user could not be verified.

In other embodiments, an exemplary privacy protection system may comprise a control center configured to register a subscriber providing goods or services to users to the privacy protection system. In addition, such an exemplary system may also comprise a registration center associated with the control center and configured to receive identification data from a user purported to identify a user of a subscriber's goods or services. In such embodiments, the control center may be configured to access at least two information sources having records related to the identification data, wherein the at least two information sources are unrelated to one another. Moreover, the control center may be configured to determine if the identification data accurately identifies the user using one or more of the related records from each of the at least two information sources. Also, the control center may be further configured to verify the identity of the user to the subscriber based on the determination.

In other aspect, the disclosed principles may provide an exemplary privacy protection method that comprises providing a check having a check number and issued in the name of a user. In such embodiments, the method may further comprise generating a unique security number and a unique security code for the check, and storing the check number, security number and security code in a database. Additionally, such an exemplary method can further comprise providing access to the database to a subscriber of the privacy protection method such that the subscriber may verify the authenticity of the check, when presented to the subscriber for payment, based on a comparison of at least the security number and security code on the check with the security number and security code stored in the database. Of course, all of the above-described exemplary embodiments are provided for illustrative purposes only, and are not intended to limit the scope of the invention are broadly defined in the appended claims.

### BRIEF DESCRIPTION OF THE DRAWINGS

Embodiments are illustrated by way of example in the accompanying figures, in which like reference numbers indicate similar parts, and in which:

FIG. 1 is a diagram illustrating an embodiment of the privacy protection system in accordance with the disclosed principles;

FIGS. 2A-2C are flow diagrams illustrating an embodiment of a privacy protection method in accordance with the disclosed principles;

FIG. 3 is a diagram illustrating an embodiment of a subscriber of the privacy protection system in accordance with the disclosed principles;

FIG. 4 is a diagram illustrating another embodiment of a privacy protection system in accordance with the disclosed principles; and

FIGS. 5A and 5B are diagrams illustrating an embodiment of a company check used in connection with the system of FIG. 4 and in accordance with the disclosed principles.

### DETAILED DESCRIPTION

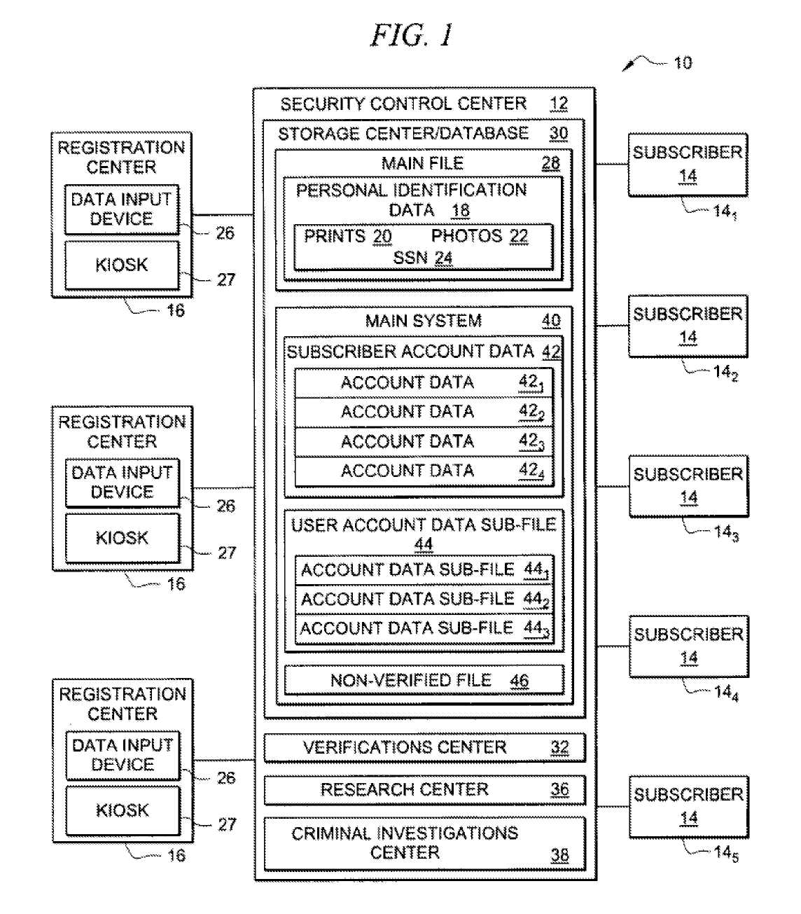

Various embodiments and the advantages thereof are best understood by referring to FIGS. 1-5B, like numerals being used for like and corresponding parts of the various drawings.

FIG. 1 is a diagram illustrating an exemplary embodiment of a privacy protection system 10 in accordance with the disclosed principles. In the embodiment illustrated in FIG. 1, privacy protection system 10 is operable to reduce and/or eliminate the likelihood of identity theft and fraud. For example, privacy protection system 10 comprises a system and method to reduce and/or eliminate the likelihood of unauthorized use of sensitive and private information, such as, for example, a social security identification number (SSN). In general, a privacy protection system in accordance with the disclosed principles provides subscribers of the system, such as credit card issuers, banks, etc., independent verification of the identity of individuals attempting to do business with the subscriber. Moreover, the independent verification provided by a protection system in accordance with the disclosed principles does not rely solely on the information accessible, provided or maintained by the entity that issued a piece of identification data to the individual. Importantly, once a user has fraudulently obtained a piece of identification data, such as a driver's license or social security number, relying solely on the issuing entities' records does nothing to detect the fraudulent activity, and actually exacerbates the identity theft problem by confirming the fraudulently obtained identification data through the issuances of another piece of fraudulently obtained identification data. Accordingly, not only may a system in accordance with the disclosed principles check with the entity that issued the piece(s) of identification data presented by a user, but it also may review the records of that issuing entity such that older records can be actively compared to current records in an effort to determine if the currently issued identification data is correct. Furthermore, as discussed in detail below, the disclosed technique also checks at least one other informational source or database, and typically several other information sources, not administered by the issuing entity in order to independently verify the identity of the user.

In the embodiment illustrated in FIG. 1, privacy protection system 10 comprises a security control center 12, one or more subscribing entities 14 and one or more registration centers 16. In operation, security control center 12 registers and verifies the identity of a user of system 10 and is operable to determine whether an unauthorized use of a SSN or other user-identifying item of information has occurred, whether any fraudulent accounts have been established with any of subscribers 14, and/or whether any fraudulent transactions have occurred or are about to occur with any of subscribers 14, including unauthorized cashing of checks, unauthorized credit card charges, etc. With a privacy protection system established in accordance with the disclosed principles, subscribers, such as banks, private companies, governmental offices, or any other entity or organization needing authentication of the identity of an individual, can subscribe to and employ the privacy protection system to independently authenticate and verify the true identity of a user.

In the embodiment illustrated in FIG. 1, subscribers 14 can be any type of entity such as, for example, a bank, a grocery store, a gas station, a restaurant, a hotel, a corporation, or any other financial or non-financial entity, including any type of federal, state, or local governmental entity (e.g., the United States Passport Agency, a state driver's license/identification issuing office, etc.) that may be adversely impacted by fraudulent activity, such as, for example, theft of and/or unauthorized use of a SSN, check fraud and/or unauthorized credit card charges. In the embodiment illustrated in FIG. 1, system 10 comprises five subscribers 14₁, 14₂, 14₃, 14₄ and 14₅; however, it should be understood that any number of subscribers 14 (e.g., a greater or fewer number of subscribers 14) may be part of system 10 and may be located at any geographic location around the country or even the world. For example, subscribers 14 may comprise a banking corporation having two-thousand satellite branches located around the country. Likewise, subscribers 14 may comprise a major oil corporation having a thousand gas stations located across the country. In the embodiment illustrated in FIG. 1, subscribers 14 subscribe to system 10 to reduce and/or eliminate fraudulent transactions with the subscriber 14.

In the embodiment illustrated in FIG. 1, registration centers 16 are provided to enable a new/potential user to register with and otherwise be identified by privacy protection system 10. According to some embodiments, registration centers 16 comprise a local Social Security Administration branch office, a bank, or any other type entity or location that is affiliated with the privacy protection system 10.

In operation, the new/potential user of system 10 registers with system 10 at any registration center 16. During registration, the user provides personal identification data 18, e.g., unique data about himself or herself for identity verification and use by system 10. According to some embodiments, personal identification data comprises finger print images 20, a digital photograph 22 of the user (e.g., a digital photograph of the user's face), and/or the user's SSN 24. It should be understood that personal identification data 18 may comprise any other data/information unique to the potential user, such as, for example, deoxyribonucleic acid (DNA), eye scan data, or any other form of unique identification now known or hereinafter known. According to some embodiments, each registration center 16 employs a data input device 26 (e.g., a computer terminal) to collect personal identification data 18 from the user for registration and verification purposes. In operation, once personal identification data 18 is collected, the personal identification data is stored in a main file 28 and system 10 identifies the potential user as “registered” on the system but not “verified” (OSNV) to alert all subscribers 14 that the identity of the user has not been verified to be correct even though the user is now registered with the system (e.g., that the SSN has not been confirmed to be stolen and/or otherwise counterfeit and that the user is the physical owner of SSN 24). In the embodiment illustrated in FIG. 1, main file 28 is stored in a database 30 of security control center 12; however, it should be understood that main file 28 may be stored at a particular registration center 16 or even remotely at any other location. According to some embodiments, registration center 16 comprises a kiosk 27 or other designated private/enclosed area to provide privacy to the user when registering on system 10.

In some embodiments, kiosks 27 may be used to complete portions of the registration process. Moreover, kiosks 27 may be used by users to add additional accounts, such as a new credit card account, to their main file 28 for protection. Such kiosks 27 may be used to help provide privacy for users as they enter information into the system 10. In other embodiments, the kiosks 27 may be employed to help ease the time required by employees of a subscriber 14 during the user's registration process. For example, once a user provides initial personal information to an employee of the subscriber 14, and thus the user main file 28 is created, the user may then be sent to a kiosk 27 to finish the registration process. More specifically, the user's main file 28 may be linked to the user's fingerprint or other identification feature, and once at the kiosk 27, the user can then access his main file 28 using that identification feature. Once the main file 28 is retrieved, the user can then be prompted to provide one or more pieces of additional personal identification data 18 via the kiosk 27, as needed, without taking up more time of the subscriber's employee.

Additionally, once the user's main file 28 is on system 10, users may use kiosks 27 to perform any number of commands at any time after the registration of the user with the system 10. In such embodiments, exemplary commands could include establishing a new P.I.N. The user could also enter information regarding additional accounts, such as credit card accounts, to be protected by the system 10. Entering various other accounts could then be organized using new sub-files created for each account, wherein each sub-file is associated with the user's main file 28. The kiosk 27 may even include magnetic strip card swipe capability to help enter each account's information. The user could also use a kiosk 27 to change their contact information should they move, etc. Moreover, changing contact information itself may require some confirmation, if desired. For example, the system 10 may require that an email and/or text may be sent to the current contact information on file that changes are being made, and such confirmation messages may even include confirmation codes required to make changes to the user's account information. Another command that may be accessed via a kiosk 27 could be a running total of accounts, official ID/Driver's License providers, or other types of sub-files associated with the user's main file 28. Still further, users may employ a kiosk 27 to voluntarily suspend verifications of certain accounts/sub-files associated with their main file 28.

In the embodiment illustrated in FIG. 1, security control center 12 comprises database 30 for storing information collected and/or used by registration centers 16 and subscribers 14. Security control center 12 further comprises a verifications center 32, a research and investigations center 36, and a criminal investigations center 38. In operation, security control center 12 is operable to verify the identity of the potential user (e.g., to verify that the potential user is the actual owner of the SSN or other identification data provided to system 10, and to identify theft of identity, such as, for example, the unauthorized use of a SSN 24 during registration and/or during subsequent uses of a SSN 24 after a user has been registered and verified. In addition, security control center 12 is operable to identify fraud, such as, but not limited to, unauthorized check cashing and/or unauthorized credit card charges, and report the same to local law enforcement authorities via the criminal investigations center 38.

In the embodiment illustrated in FIG. 1, database 30 comprises a main system database 40. Main system database 40 stores information pertaining to each subscriber 16 and the user of system 10. For example, in the embodiment illustrated in FIG. 1, main system database 40 comprises subscriber account data 42 (e.g., account data associated with subscribers 14) and user account data 44 (e.g., accounts owned by the user corresponding to subscriber account data 42). Thus, for example, in the embodiment illustrated in FIG. 1, if subscriber 14₁ is the State of Texas, account data 42₁ may correspond to data associated with all issued Texas Driver's licenses. Similarly, account data 42₂ may correspond to credit card accounts associated with all accounts managed by subscriber 14₂ (e.g., XYZ credit card company). Likewise, account data 42₃ and 42₄ may correspond to accounts associated with subscriber 14₃ and 14₄, respectively. User account data 44 comprises, for example, account data sub-files 44₁, 44₂, 44₃ owned by a particular user that is associated with a corresponding subscriber 14. For example, user account data sub-file 44₁ may comprise the user's driver's license data, user account data sub-file 44₂ may comprise the user's account information managed by subscriber 14₂ (e.g., xyz credit card company), and user account data sub-file 44₃ may comprise the user's account information managed by subscriber 14₃. It should be understood that while three account sub-files 44 are illustrated in FIG. 1, a greater or fewer number of accounts may be established by a user.

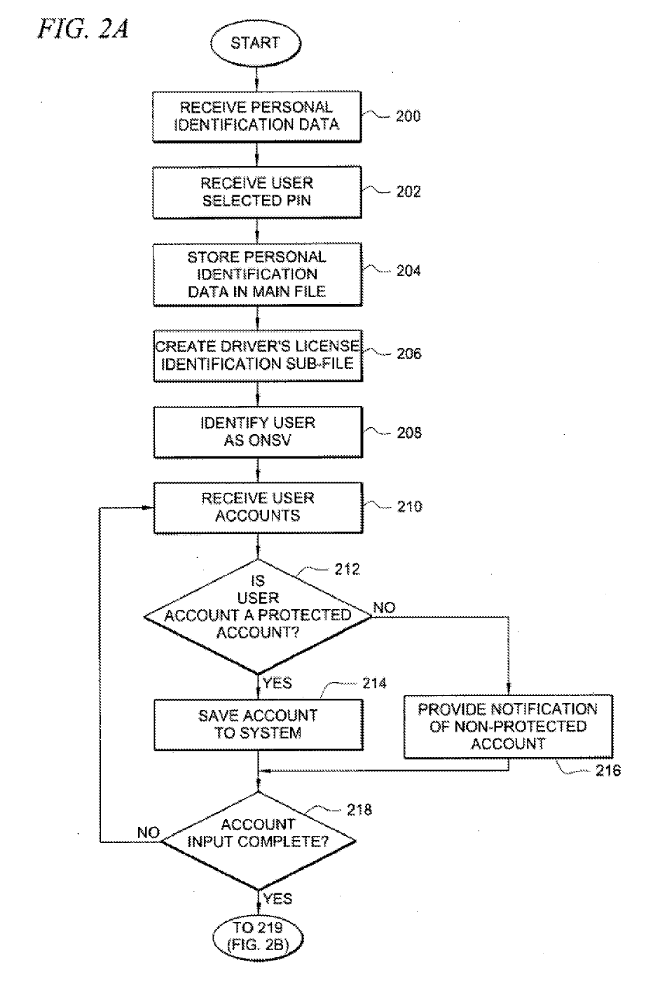

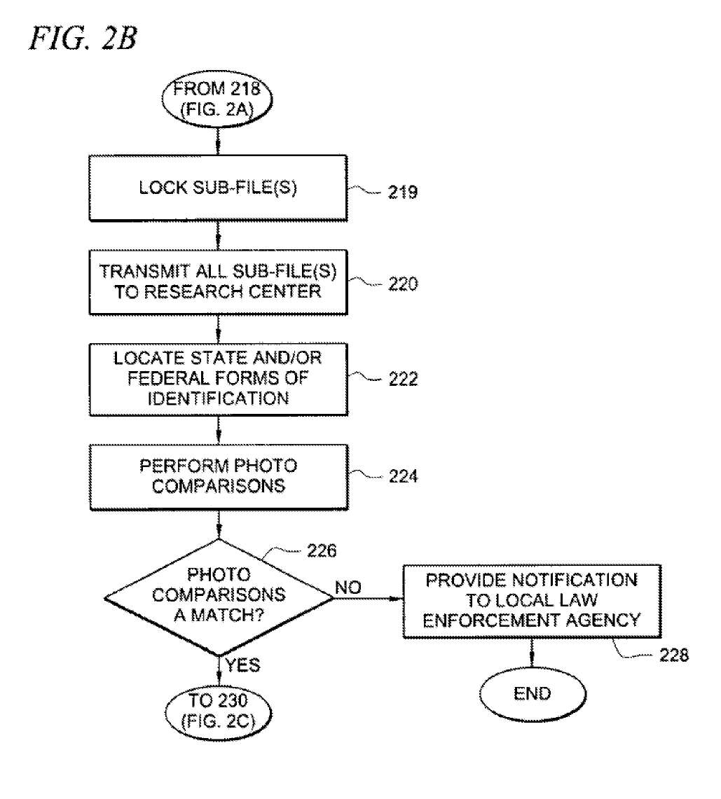

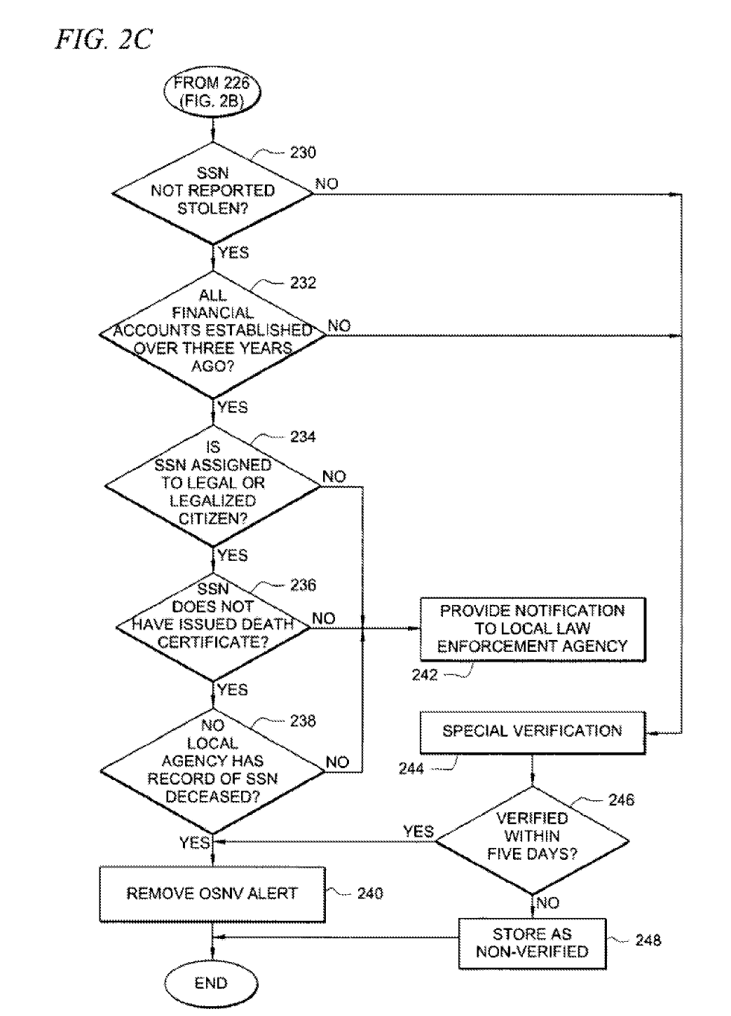

FIGS. 2A-2C are flow diagrams illustrating an embodiment of a privacy protection method in accordance with the disclosed principles. The method begins at block 200 where system 10 receives personal identification data 18 (FIG. 1). For example, personal identification data 18 is input into system 10 via input device 26 (FIG. 1) to collect and input into system 10 fingerprint data 20, digital photograph 22 and the user's SSN 24 and/or any other designated personal identification data 18. According to some embodiments, personal identification data 18 is input into system 10 by an agent/employee of registration center 16 (FIG. 1); however, it should be understood that a user may directly input such data into system 10 via input device 26, and may also employ a kiosk 27 to input some or all of the information. The method proceeds to block 202, where system 10 receives a personal identification number (PIN) selected by the user. The PIN enables a user, once verified, to identify himself or herself to system 10 via input of the PIN. According to some embodiments, the PIN can be any alpha-numeric combination of characters selected by a user to access system 10. In other embodiments, users may use biometric information (e.g., a fingerprint) to identify themselves to the system 10, or perhaps a combination of both a PIN and fingerprint. The method continues at block 204 where system 10 stores personal identification data 18 in main file 28. Once stored in main file 28, system 10 accesses main system database 40 to identify a driver's license and/or state identification file corresponding to personal identification data 28 provided by the user to establish a driver's license/identification sub-file 44₁, as indicated at block 206. For example, according to some embodiments, system 10 will access state driver's license and/or identification records databases stored in main system database 40 (e.g., subscribers account data 42) to locate the corresponding driver's license and/or state identification file(s) associated with personal identification data 18 provided by the user at registration center 16. Once identified, the method proceeds to block 208, where the user is identified by system 10 as ONSV (i.e., registered, but not yet verified).

The method proceeds to block 210 where system 10 receives account data input by the user regarding accounts assigned to and/or owned by the user. According to some embodiments, account data is input directly into system 10 by the user (e.g., without an agent/employee of a registration center 16) so that all account information (e.g., account numbers, etc.) remains confidential solely for the use of the user. For example, during registration a user may manually input each account number (e.g., via a computer keyboard), or in the alternative, the user can swipe and/or scan a credit card, a driver's license, a blank check associated with a checking account, etc. through a scanner or other device capable of recognizing the account. According to some embodiments, the user will input account information inside kiosk 27 (FIG. 1) or any other designated private/enclosed area to provide privacy to the user to enable the user to enter each account confidentially into system 10.

Once an account has been input into system 10, system 10 will determine at decision block 212 whether the account is a protected account (e.g., an account 42 established with a subscriber 14) stored in main system database 40. If the account is a protected account, system 10 will automatically save the user account information in database 40 as a sub-file 44 (one for each new account), as indicated at block 214. The method proceeds to decision block 218 to determine whether the user has additional accounts to input. If additional accounts are available for input, the method returns to block 210 to enable system 10 to receive the additional account information. If at decision block 212 system 10 determines that the account is a non-protected account (e.g., an account that is established with an entity other than a subscriber 14 such that no account data 42 is present), then no account information will be saved and system 10 will provide a notification to the user that the account is a non-protected account, as indicated at block 216. For example, in the event the user has a credit card account with a non-subscribing credit card company, the user will be notified that the account is not protectable via system 10. If no additional accounts are to be entered into system 10 at decision block 216, the method proceeds to block 219 (FIG. 2B) to lock and/or otherwise secure all sub-files 44 to prevent use until system 10 has verified the driver's license sub-file 44₁.

A protection system 10 in accordance with the disclosed principles differs greatly with existing techniques used by companies/agencies to verify user identities. More specifically, existing techniques simply rely on the issuer of a user's identification information to verify its authenticity. For example, if an applicant provides a driver's license to prove his identity to a company, such as a credit card issuing company, the company then typically do nothing more than confirm that the driver's license exists in the state's Department of Motor Vehicles records. However, if the driver's license was improperly obtained in the first place, the identity of the applicant has not been verify and the company issues a credit card to perpetrator of identity, thus perpetuating the identity theft. In stark contrast, the disclosed verification approach actively verifies the identity of such an applicant without solely relying on the issuer of the identification data. Stated another way, a system in accordance with the disclosed principles actively verifies the identification data provide by a user in order to independently authenticate users on behalf of subscribing members to the system 10. Furthermore, a system in accordance with the disclosed principles independently verifies each separate account (e.g., credit card, etc.) that even a verified user associates with his main file. Still further, even after a user and his selected accounts have been authenticated and verified, the disclosed principles can provide for ongoing protection for both users and subscribers. For example, the system 10 may periodically ensure that a user's information data, such as a SSN or driver's license, is not later attempted to be used by another person, such as detecting whether such information is newly associated with a person that has not been verified to be the authenticated user.

Turning back to FIGS. 2A-2C, a system in accordance with disclosed principles will independently attempt to verify that the identification data provided by the user is in fact truly his. For example, at block 220, research center 36 (FIG. 1) receives all account sub-files 44 associated with the user. According to some embodiments, a research employee and/or an automated software program will search and locate, if any, all prior state issued driver's licenses, state identifications, passports, or any other governmental issued photo identification, as indicated at block 222. At block 224, the obtained photo identification(s) are compared against digital photo 22. According to some embodiments, the comparison of digital photos can be conducted by the research employee and/or conducted electronically by photo comparison software.

At decision block 226, system 10 confirms whether the photos generate a match. In the event no match was established between the photos, the user's thumbprint 20 and digital photo 22 stored in main file 28 would be processed into a criminal report and electronically delivered to the local police department (e.g., the police department where the registration attempt was made), as indicated at block 228. According to some embodiments, thumbprint 20 and digital photo 22 would be transferred to the criminal investigations center 38 (FIG. 1), which will create the criminal complaint and communicate directly with local law enforcement agencies. If at decision block 226 a match was established between the photos, the method proceeds to block 230 (FIG. 2C) where a system entry test is conducted at decision blocks 230-246 to enable system 10 to unlock and/or otherwise verify that the user is the person assigned to SSN 24.

The system entry test begins at block 230, where system 10 determines whether or not SSN 24 has been reported stolen. For example, system 10 determines whether SSN 24 has been reported stolen to entities such as the Federal Trade Commission, a credit reporting agency, or any other entity. If SSN 24 was not reported as stolen, system entry test proceeds to decision block 232, where it is determined whether the financial checking accounts assigned to any of the sub-files 44 were established three or more years ago, since it is highly unlikely that fraudulent accounts would be open for more than three years. Of course, other exemplary time frames may also be employed with the disclosed principles. Additionally, the system entry test may also verify that the SSN 24 is associated with a telephone number for, for example, at least three years. Similarly, the system entry test may also determine if the SSN 24 is associated with one or more utilities, such as an electric or water bill, for at least three years. If all of the financial and/or utility accounts are determined to be associated with the SSN 24 and were created more than three years ago (or whatever time frame is employed in the verification process), the method proceeds to decision block 234, where it is determined whether or not SSN 24 is assigned to a legal or legalized citizen. If SSN 24 is assigned to a legal or legalized citizen by searching immigration records stored in main system 40 or otherwise accessible by local, state and/or federal governments, the method proceeds to decision blocks 236 and 238, to determine whether a death certificate has been associated with SSN 24 at the Social Security Administration and whether or not SSN 24 has been associated with a deceased person at the local and/or state level. If a determination is made at blocks 236 and 238 that SSN 24 is not associated with a deceased person via records on the federal and state level, the method proceeds to block 240 to remove the OSNV alert from system 10.

If at decision block 234 SSN 24 is determined to be assigned to an illegal alien and/or if at blocks 246 and/or 238 it is determined that SSN 24 is associated with a deceased person, the method proceeds to block 242, where thumbprint 20 and digital photo 24 are processed into a criminal report and electronically delivered to the local police department (e.g., the police department where the registration attempt was made) via, for example, criminal investigations center 38.

If, however, at decision block 230 it is determined that SSN 24 was reported stolen and/or if at decision block 232 one or more of the financial checking accounts was established less than three years ago (or other predetermined period of time), the method proceeds to block 244 for special verifications to verify whether the user is in fact the physical owner of SSN 24. According to some embodiments, at block 244, such special verification is conducted via verifications center 32 (FIG. 1) to determine whether the person who created the main identification file 28 is the physical owner of SSN 24. According to some embodiments, finger print file 20 will be compared against the finger print files recorded at the National Criminal Investigation Center (NCIC). Thus, if a convicted criminal is attempting to steal the user's identity, the criminal's finger print will be located in the NCIC system. Because a SSN is commonly used when renting apartments, obtaining home loans and for numerous other researchable reasons, verifications center 32 is able to locate the physical location of the physical owner of SSN 24. Once it has been verified that the physical owner of SSN 24 is the same as the person that created the main identification file, a field verification will be conducted.

Therefore, in application of the disclosed principles, the databases that are accessed by system 10 would not typically be accessible by subscribers or entities that issue identification data (other than of course access to their own databases). For example, if a user presents a driver's license to identify himself, the system 10 may confirm with the issuing state that the driver's license is valid, as well as accessing the states historical records for prior versions of the user's driver's license to compare photos on the licenses, as described above. In addition, however, the system 10 will further access other, unrelated informational databases, such as the databases of one or more utility companies, as mentioned above, to compare the names and addresses in the utility companies' files with the driver's license records discovered. Still further, the system 10 may also access bank account or mortgage records to further cross-check the previously discovered information with the those records. Thus, since a system 10 as disclosed herein will have the ability to access numerous unrelated databases to which any single entity would not have access, the disclosed system 10 will be capable of providing identity verification through cross-referencing records across an almost infinite number and type of informational databases. This cross-referencing of multiple unrelated databases in an active attempt to verify the identity of the user provides an unprecedented level of identity verification through an independent system 10 having access to a number of databases not previously accessible by a single financial, credit or utility company, a merchant of goods and/or services, or even state or national agency.

According to some embodiments of system 10, field agents having mobile finger print units will travel to a user's residence to obtain a finger print for verification that the user is the same user who provided fingerprint 20 at registration. Once the finger print has been obtained, the field agent will travel to a pre-designated registration center 16 for downloading the finger print data to system 10. In the event the mobile unit is taken to a non-designated registration center, the mobile unit will be unable to download the fingerprint data. Similarly, field agents may be selected for such identification assignments on a random basis, and therefore if it is determined that an unauthorized field agent obtained the identification data from the user, the attempted special verification may be disallowed. Such an approach adds an extra layer of fraud prevention in that corrupted field agents cannot be guaranteed to be sent to authenticate certain users. According to some embodiments, when coupling the mobile finger unit to system 10 at registration center 16, the field agent will identify himself or herself on the mobile unit by an employee identification number. In addition, the field agent will provide his or her finger print to access system 10 prior to downloading data from the mobile unit to system 10.

If at block 246 finger print 20 is verified, the method proceeds to block 240, where system 10 removes the OSNV alert. If at block 246 the finger print 20 is not verified, personal identification data 18 will be removed from main file 28 and stored in a non-verified database 46. Furthermore, the criminal complaint center 34 will be notified and will use the finger print and digital photo to identify the physical identity of the potential criminal that tried to obtain protection. Once identified, criminal complaint center 34 will prepare and transmit a criminal complaint to local law enforcement authorities. Additionally, in the event five days elapse from the creation of main file 28 and verification, personal identification data 18 will be removed from the main file and saved on the non-verified database, as indicated at block 248. As before, a different amount of time may also be employed by the disclosed principles. Each time a citizen desires to establish a main-identification file, the information stored in the non-verified database will be checked against the newly provided information. In the event a non-match is identified (e.g., more than two fingerprint matches with a single social security number), the investigations center 38 will be notified to prepare and transmit a criminal complaint.

According to some embodiments, when ongoing protection as mentioned above is occurring, system 10 may provide a user notification when a user's SSN 24 is used. Accordingly, system 10 will provide a notification to a user when that user's particular SSN 24 is input into system 10. For example, if a third-party attempts to use SSN 24 to open a credit card account with subscriber 14, system 10 will provide an electronic notification (e.g., an email) or send a voice notification (e.g., a telephone message via electronic message or by voice) to indicate that SSN 24 was used, where SSN 24 was used, and for what purpose SSN 24 was used (e.g., to open a credit card account, to obtain a driver's license, to establish a bank account, etc.).

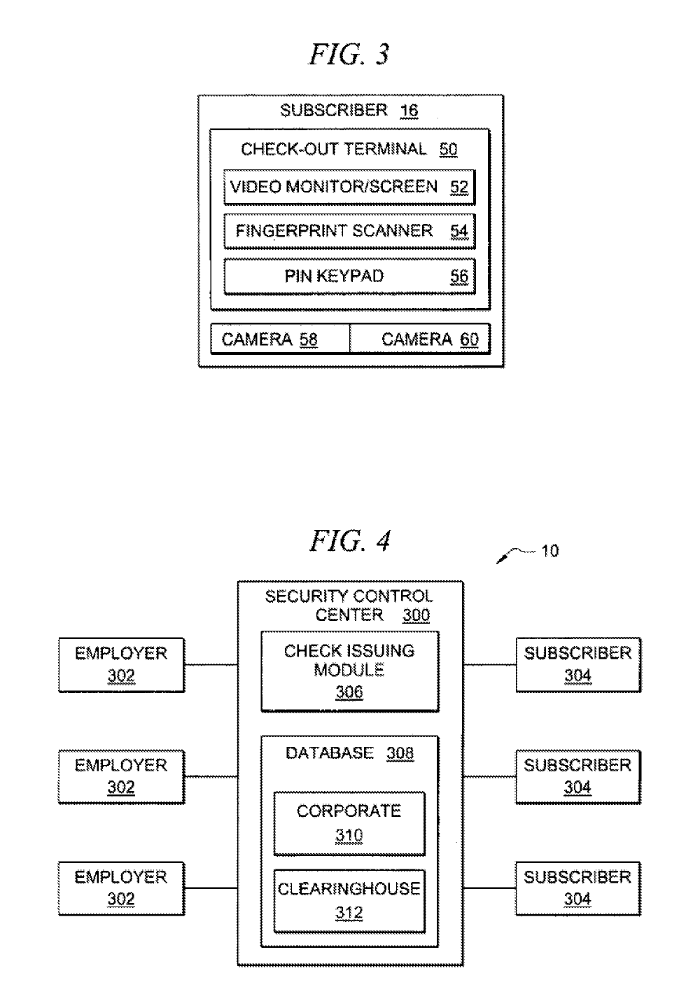

FIG. 3 is a diagram illustrating an embodiment of a subscriber 16. In the embodiment illustrated in FIG. 3, subscriber 16 is a subscriber such as a convenience store that accepts checks and/or credit cards. In the embodiment illustrated in FIG. 3, subscriber 16 comprises a “check-out” terminal 50 comprising a video monitor 52, a finger print scanner 54 and a PIN keypad 56. Subscriber 16 further comprises a plurality of security cameras 58 and 60. In operation, if a user enters the convenience store for gas and/or other items and pays with a protected credit card (e.g., an account established as protected by system 10), the clerk will input the account numbers and/or the customer will swipe the card to enter the account information. Once the account information is entered into system 10, system 10 will request verification by inputting the PIN via keypad 56 and/or providing the user's finger print via finger print scanner 54. Once the PIN is entered, the digital photo stored in main file 28 (FIG. 1) will appear on video screen 52 to enable the clerk to visually verify the identity of the customer.

According to some embodiments, finger print scanner 54 may be part of keypad 56 such that when pressing keypad 56, finger print images can be recorded. In addition, according to some embodiments, the keys on keypad 56 may be randomly arranged so as to require the customer to look toward keypad 56 when inputting the PIN; accordingly, cameras may be aligned and/or incorporated on keypad 56 to capture the image of the customer when inputting the PIN.

According to some embodiments, in the event the incorrect PIN is used and/or there is no photo match, cameras 58 and 60 will be activated. In the event a second attempt to enter the PIN is incorrect, a digital image of the customer and/or finger print images will be saved by system 10. Of course, the digital image and/or finger prints may also be captured after just the first unsuccessful attempt, or if greater than two attempts have been performed. Accordingly, because the print and/or photo was saved by system 10, the clerk can instantly transmit the information to criminal investigations center 38. Once received, the criminal investigations center 38 will prepare a criminal report, including the finger print and digital photo taken at the convenience store, for transmittal to the local law enforcement agency.

FIG. 4 is a diagram illustrating another embodiment of a privacy protection system 10 in accordance with the disclosed principles. In the embodiment illustrated in FIG. 4, privacy protection system 10 comprises a security control center 300, one or more employers 302 that issue forms of payment, such as, for example, paychecks, and one or more subscribers 304, which are registered with system 10 to cash such paychecks. In the embodiment illustrated in FIG. 4, privacy protection system 10 comprises three employers 302 and three subscribers 304; however, it should be understood that an infinite number of employers 302 and subscribers 304 may be registered with system 10 for privacy protection services. In the embodiment illustrated in FIG. 4, system 10 is operable to provide secure payment processing for employers 302 to ensure that payroll check and other forms of payment to company employees, vendors or any other third-parties are secure and not susceptible to forgery and/or unauthorized cashing or depositing. In the embodiment illustrated in FIG. 4, system 300 comprises a check issuing module 306 and a database 308. In operation, when a particular employer 302 prepares a check, such as, for example, a paycheck for an employee, check issuing module 306 is utilized by employer 302 to provide a unique check identifier to identify each check.

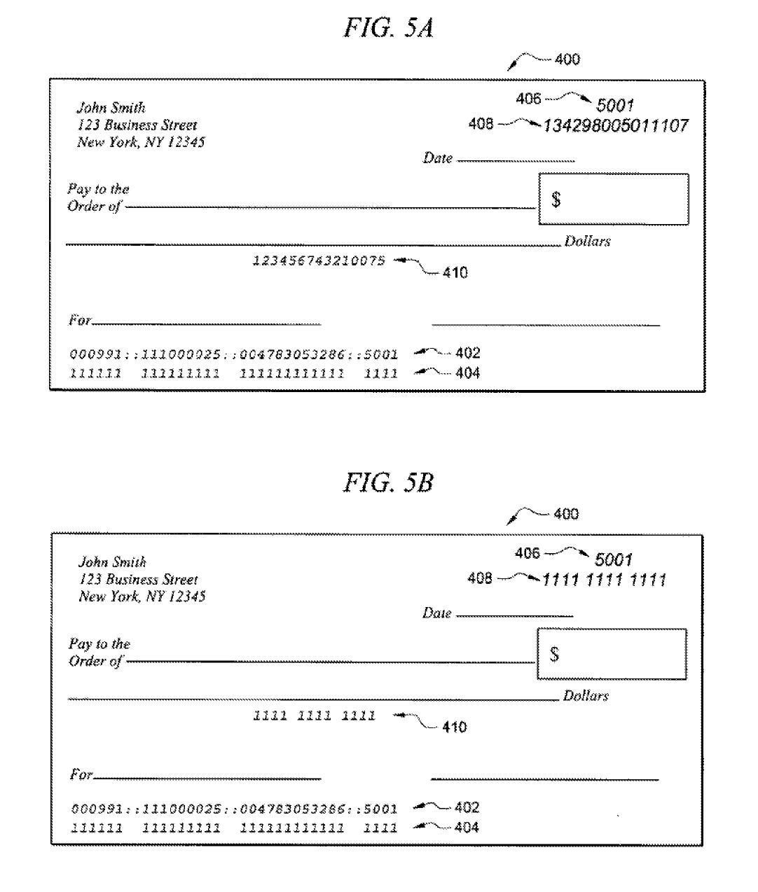

FIG. 5A is a diagram illustrating an embodiment of a typical company check 400 used in connection with system 300 (FIG. 4). In the embodiment illustrated in FIG. 5A, check 400 comprises ABA routing number 402, ABA routing number in bar code format 404, a check number 406, a random security number 408 associated with each check number 406 and a random security code 410 generated with each check number 406. In the embodiment illustrated in FIG. 4, random security number 408 and random security code 410 each comprise a randomly generated number generated by check issuing module 306 that is fifteen characters in length; however, it should be understood that number 408 and code 410 may comprise a greater or fewer number of characters.

In operation, each employer 302 will issue each employee an employee identification number for identification purposes. Further, employers 302 will enable the employee on how the employee would like to process its check 400 each time a check 400 is issued. For example, the employee may decide to cash check 400 at one or more particular subscribers 304 upon receiving check 400. Alternatively, the employee may elect to have employer 302 provide payment via direct deposit into the employees account. According to some embodiments, in the event an employee chooses not to have direct deposit into their respective account, each employee will create a PIN number to identify the employee to the subscriber each time a check 400 presented to a subscriber for cashing and/or deposit.

In operation, each time a check 400 is printed for a particular employee number, check issuing module 306 will store with respect to each check 400, the check number 406, the random security number 408, and the random security code 410 in database 308. According to some embodiments, check number 406, random security number 408 and random security code 408, along with the PIN, are stored in a corporate database 310 accessible by subscribers 304. Accordingly, when subscribers 304 are presented with a check for cashing, subscribers 304 can access database 310 to verify that the information stored in database 310 matches the information presented on check 400. For example, when employer 302 issues a paycheck to a particular employee, check issuing module 306 will generate a random security number 408 and a random security code 410 for each check and associate the employee identification number along with the employee's pin number. Check issuing module 306 will send this information to database 310 such that when subscriber 304 is presented with check 400, the subscriber 304 will confirm, after the employee enters his or her PIN number, that the information on check 400 matches the information stored in database 308.

According to another embodiment of system 10, when an employee desires to have his or her check directly deposited into his or her account electronically (or in the event the employee self-deposits his or her checks into his or her account), no PIN will be necessary since he or she will not be cashing the checks. In such instances, check issuing module 306 will generate a random security number 408, a random security code 410 and associate the employee identification number for each check 400. Check issuing module 306 will send this information to database 312 to enable the bank to verify that the information associated with check 400 matches the information stored in database 310.

According to another embodiment of system 10, random security number 408, random security code 410 and ABA routing number 404 will appear in bar code format to be read by scanners at a particular subscriber location as illustrated in FIG. 5B. Furthermore, according to other embodiments, check issuing module 306 will include the ability for employers 302 to input into system 10 a subscriber identification number (SIN). The SIN will allow employers to input locations for particular subscribers 304; accordingly, if the employee cashes his or her checks at a subscriber 304, that location will be the subscriber to receive the ability to verify numbers 404, 408 and 410.

Embodiments may be implemented in software and can be adapted to run on different platforms and operating systems. In particular, functions implemented by check issuing module 306, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer readable medium can be, for example, but is not limited to, an electronic, magnetic, optical, electromagnetic, infrared, or semi-conductor system, apparatus, device, or propagation medium.

According to embodiments, employees of system 10 (e.g., agents/representatives at registration centers 16, field agents, employees of subscribers 16 or any other person employed by system 10 must have prior approval before accessing system 10. According to some embodiments, eighteen employees will be granted authority to grant system access to any new employee. In operation, a minimum of six of the eighteen employees must, when granting approval, provide their fingerprints at dedicated terminal(s) in order to provide their approval once proper background checks and identity verifications of the employees have been completed. It should be understood that a greater or fewer number of employees may be granted the authority to grant approval and a greater or fewer number of required fingerprints may be required to grant the approval. Preferably, all six approval employees must verify via a fingerprint at the same time and at the same physical location. Thus embodiments of the privacy protection system 10 reduce and/or eliminate the likelihood of identity theft, fraud and/or forgery.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

What is claimed is:

1. A privacy protection method, comprising:
registering a subscriber, wherein the subscriber provides goods or services to users;
receiving identification data purported to identify a user of the subscriber's goods or services;
accessing at least two information sources having records related to the identification data, wherein the at least two information sources are unrelated to one another;
determining if the identification data accurately identifies the user using one or more of the related records from each of the at least two information sources; and
verifying the identity of the user to the subscriber based on the determination.

2. The method of claim 1, wherein one of the at least two information sources is associated with an entity responsible for maintaining records related to the identification data of the user.

3. The method of claim 1, wherein the identification data comprises at least a finger print of the user.

4. The method of claim 1, wherein the identification data comprises at least a photo of the user.

5. The method of claim 4, wherein the determining comprising comparing the photo of the user to an image on a state identification card in one of the records of the at least two information sources and issued in the name of the user.

6. The method of claim 1, wherein the identification data comprises at least a social security number of the user.

7. The method of claim 6, wherein the determining comprises accessing one or more records found from one of the at least two information sources to determine whether the social security number has been reported stolen.

8. The method of claim 7, the determining comprises accessing one or more records from one of the at least two information sources to determine whether the social security number has been associated with a deceased person.

9. The method of claim 7, the determining comprises accessing one or more records from one of the at least two information sources to determine whether the social security number is issued to at least a legalized citizen.

10. The method of claim 1, the determining comprises accessing one or more records from one of the at least two information sources to determine whether any financial account associated with the identification data of the user is less than three years old.

11. A privacy protection system, comprising:
a control center configured to register a subscriber providing goods or services to users to the privacy protection system;
a registration center associated with the control center and configured to receive identification data from a user purported to identify a user of a subscriber's goods or services; and
wherein the control center is configured to:
access at least two information sources having records related to the identification data, wherein the at least two information sources are unrelated to one another,
determine if the identification data accurately identifies the user using one or more of the related records from each of the at least two information sources, and
verify the identity of the user to the subscriber based on the determination.

12. The system of claim 11, wherein one of the at least two information sources is associated with an entity responsible for maintaining records related to the identification data of the user.

13. The system of claim 11, wherein the identification data comprises one or more of a finger print of the user, a photo of the user, or a social security number of the user.

14. The system of claim 11, wherein the registration center comprises a terminal configured to receive the identification data and located on premises of the subscriber.

15. The system of claim 14, wherein the terminal comprises one or more of a finger print scanner, a keypad, or magnetic card strip reader.

16. A privacy protection method, comprising:
providing a check having a check number and issued in the name of a user;
generating a unique security number and a unique security code for the check;
storing the check number, security number and security code in a database; and
providing access to the database to a subscriber of the privacy protection method such that the subscriber may verify the authenticity of the check, when presented to the subscriber for payment, based on a comparison of at least the security number and security code on the check with the security number and security code stored in the database.

17. The method of claim 16, further comprising randomly generating the security number and the security code.

18. The method of claim 16, further comprising assigning a pin number to the check.

19. The method of claim 16, further comprising displaying the security number and security code on the check in a bar code format.

20. The method of claim 16, further comprising assigning an identification number associated with the user to the check.
